(19) United States
(12) Patent Application Publication
(10) Pub. No.: US 2012/0004810 A1
(43) Pub. Date: Jan. 5, 2012

(54) Vehicle-use safety control apparatus

(75) Inventors: Tomoko Kodama, Kariya-shi (JP); Tomohisa Kishigami, Obu-shi (JP)

(73) Assignee: DENSO CORPORATION, Kariya-city (JP)

(21) Appl. No.: 13/135,233

(22) Filed: Jun. 29, 2011

(30) Foreign Application Priority Data
Jun. 30, 2010 (JP) 2010-150010

(51) Int. Cl. B60R 21/00

(52) U.S. Cl. 701/45

(57) ABSTRACT

The vehicle-use safety control apparatus is configured to operate on electric power supplied from a vehicle battery mounted on a vehicle through at least one of a first electric power supply path interposed with an ignition switch of the vehicle, and a second electric power supply path interposed with a changeover switch. The vehicle-use safety control apparatus includes a running state information acquiring means to acquire running state information on whether the vehicle is running or stopped, and a switch control means to change an on/off state of the changeover switch in accordance with the running state information received from the running state acquiring means.

This application claims priority to Japanese Patent Application No. 2010-150010 filed on Jun. 30, 2010, the entire contents of which are hereby incorporated by reference.

### BACKGROUND OF THE INVENTION

1. Field of the Invention

The present invention relates to a vehicle-use safety control apparatus which operates to ensure safety of a driver and passengers of a vehicle during running of the vehicle.

2. Description of Related Art

There is known a vehicle-use safety control apparatus mounted on a vehicle which inflates air bags mounted on a vehicle when a collision of the vehicle is detected to ensure safety of the vehicle driver and passengers of the vehicle.

Such a vehicle-use safety control apparatus operates on electric power supplied from a vehicle-mounted battery. As described, for example, in Japanese Patent Application Laid-open No. H11-245762, supplying electric power to such a safety control apparatus is started when an ignition switch is turned on. Accordingly, no electric power is consumed by the safety control apparatus while the ignition switch is off.

However, in view of further improving safety of the vehicle driver and passengers, the safety control apparatus may be supplied with electric power even when the ignition switch is off.

However, to do so, a substantial increase of the dark current of the safety control apparatus has to be accepted.

### SUMMARY OF THE INVENTION

An embodiment provides a vehicle-use safety control apparatus configured to operate on electric power supplied from a vehicle battery mounted on a vehicle through at least one of a first electric power supply path interposed with an ignition switch of the vehicle, and a second electric power supply path interposed with a switch means, comprising:

a running state information acquiring means to acquire running state information on whether the vehicle is running or stopped; and

a switch control means to change an on/off state of the switch means in accordance with the running state information received from the running state acquiring means.

Another embodiment provides a vehicle-use safety control apparatus configured to operate on electric power supplied from a vehicle battery mounted on a vehicle through at least one of a first electric power supply path interposed with an ignition switch of the vehicle, and a second electric power supply path interposed with a switch means, comprising:

a switch state determination means to determine an on/off state of the ignition switch;

a running state determination means to determine whether the vehicle is running or stopped; and

a switch control means configured to turn on the switch means on condition that the switch control means is supplied with electric power from the vehicle battery through the first electric power supply path, and turn off the switch means on condition that the switch state determination means determines that ignition switch is in the off state, and the running state determination means determines that the vehicle is stopped.

According to the present invention, there is provided a vehicle-use safety control apparatus which can operate even when an ignition switch of a vehicle is off without substantial increase of the dark current of the safety control apparatus.

Other advantages and features of the invention will become apparent from the following description including the drawings and claims.

### BRIEF DESCRIPTION OF THE DRAWINGS

In the accompanying drawings:

FIG. 1 is a block diagram showing the overall structure of a vehicle-use air bag system as an embodiment of the invention; and

FIG. 2 is a flowchart showing a process performed by an air bag ECU included in the vehicle-use air bag system shown in FIG. 1.

### PREFERRED EMBODIMENTS OF THE INVENTION

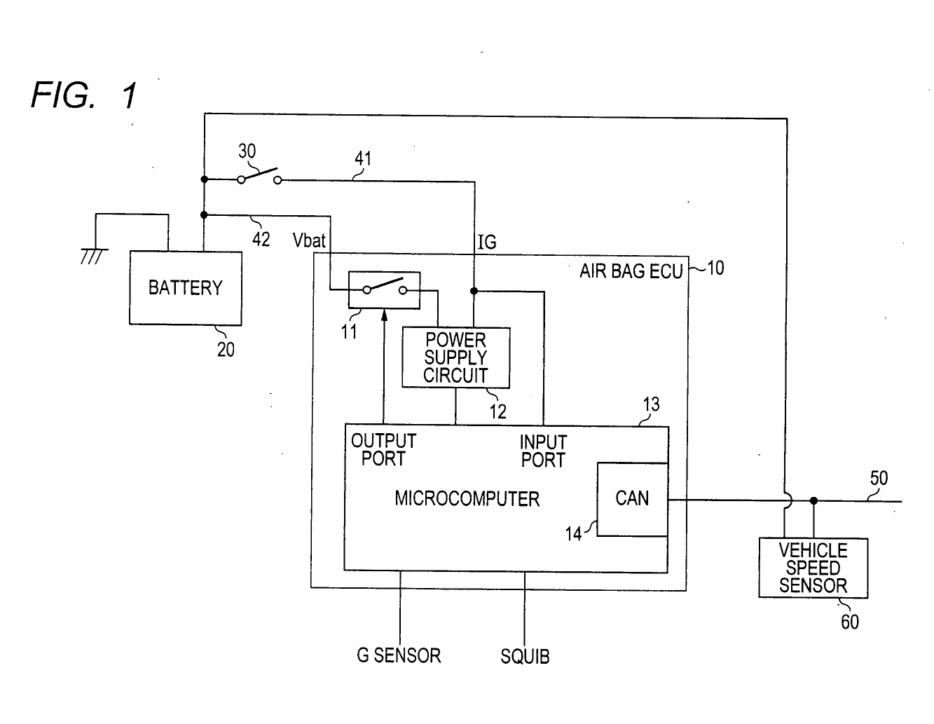

FIG. 1 is a block diagram showing the overall structure of a vehicle-use air bag system as a first embodiment of the invention.

This vehicle-use air bag system, which is a system for controlling an air bag module including a G sensor (acceleration sensor) and a squib, is constituted mainly of an air bag ECU (Electronic Control Unit) 10.

The air bag ECU 10, which is implemented by a later-described microcomputer 13, operates on electric power supplied from a vehicle battery 20. As a power supply path from the vehicle battery 20 to the air bag system, there are disposed a first power supply path 41 interposed with an ignition switch 30, and a second power supply path 42 bypassing the ignition switch 30.

The air bag ECU 10 is communicably connected to other vehicle-mounted devices constituting an in-vehicle network through a communication line 50. Next, the detailed structure of the air bag ECU 10 is explained.

As shown in FIG. 1, the air bag ECU 10 includes a changeover switch 11, a power supply circuit 12 and the microcomputer 13. The changeover switch 11 is controlled in accordance with a command signal outputted from an output port of the microcomputer 13 while the microcomputer 13 is in operation (while the command signal is not outputted). The changeover switch 11 is off while the microcomputer 13 is not in operation. The changeover switch 11 is disposed in the second power supply path 42, so that the power supply circuit 12 is supplied with electric power from the vehicle battery 20 through the changeover switch 11 while the changeover switch 11 is on.

The power supply circuit 12 generates the operating voltage of the microcomputer 13 from the battery voltage (the voltage of the vehicle battery 20), and supplies it to the microcomputer 13. In this embodiment, the power supply circuit 12 is connected to the vehicle battery 20 through both the first and second power supply paths 41 and 42. Accordingly, when at least one of the ignition switch 30 and the changeover switch 11 is on (that is, when the power supply circuit 12 is supplied with electric power through at least one of the first power supply path 41 and the second power supply path 42), the power supply circuit 12 can supply the operating voltage to the microcomputer 13.

When both the ignition switch 30 and the changeover switch 11 are off (that is, when the power supply circuit 12 is not supplied with electric power through any one of the first power supply path 41 and the second power supply path 42), since the power supply circuit 12 cannot generate the operating voltage, the microcomputer 13 does not operate, and accordingly, the air bag ECU 10 (more precisely, the microcomputer 13) consumes no electric power.

The microcomputer 13 supplies electric power to the squib of an air bag to inflate the air bags upon detecting a collision of the vehicle based on the acceleration of the vehicle measured by the G sensor. The microcomputer 13 includes a CAN controller 14 to perform communication with other vehicle-mounted devices constituting an in-vehicle network (CAN in this embodiment). The microcomputer 13 can receive a vehicle speed signal from a vehicle speed sensor 60 mounted on the vehicle through the communication line 50. FIG. 1 shows that the vehicle speed sensor 60 is directly connected to the communication line 50. However, the vehicle speed sensor 60 may be connected to the communication line 50 through another ECU.

Incidentally, the vehicle speed sensor 60 is applied with the battery voltage directly from the vehicle battery 20, so that the vehicle speed sensor 60 can operate even when the ignition switch 30 is off.

The microcomputer 13 detects whether the ignition switch 30 is in the on state or off state based on whether or not the battery voltage is applied to an input port thereof. The microcomputer 13 outputs the command signal from the output port thereof to change the on/off state of the changeover switch 11.

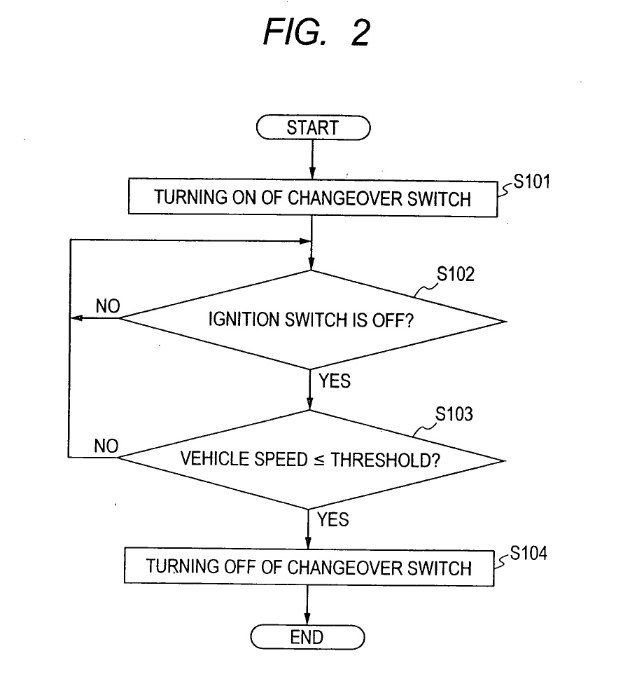

Next, a process performed by the microcomputer 13 of the air bag ECU 10 when the ignition switch 30 is turned on is explained with reference to the flowchart of FIG. 2. Before the ignition switch 30 is turned on, the changeover switch 11 is in the off state, and accordingly the microcomputer 13 is not supplied with electric power from the vehicle battery 20.

This process, which is started when the ignition switch 30 is turned on, begins by outputting the command signal from the output port to turn on the changeover switch in step S101. As a result, since the microcomputer 13 is supplied with electric power through not only the first power supply path 41 but also the second power supply path 42, the microcomputer 13 does not stop operation immediately when the ignition switch 30 is turned off.

In subsequent step S102, the process waits until the ignition switch 30 is detected to be in the off state based on the voltage applied to the input port of the microcomputer 13.

In step S103 subsequent to step S102, it is determined whether or not the vehicle speed measured by the vehicle speed sensor 60 and received in the CAN controller 14 is lower than or equal to a predetermined stop determination threshold. In this embodiment, to determine whether of not the vehicle is running, the stop determination threshold is set to a value slightly larger than 0. Normally, the ignition switch 30 is turned off after the vehicle is stopped. Accordingly, an affirmative determination is made in step S2 in normal cases.

If the determination result in step S103 is affirmative, the process proceeds to step S104 to turn off the changeover switch 11. As a result, supply of electric power from the vehicle battery 20 to the power supply circuit 12 is stopped, the microcomputer 13 stops operation, and thereafter the process is terminated.

If the determination result in step S103 is negative, the process returns to step S102. That is, the changeover switch 11 is kept in the on state until the ignition switch 30 is turned off, and the vehicle speed is reduced to lower than or equal to the stop determination threshold, in order to maintain the state where the microcomputer 13 is supplied with electric power from the vehicle battery 20 through the second electric power supply path 42. Accordingly, the air bag module is kept in the controllable state until the vehicle is stopped even if the ignition switch 30 is turned off while the vehicle is running. Incidentally, when the ignition switch 30 is turned on again before the vehicle speed is reduced to lower than or equal to the stop determination threshold, the process returns to step S102.

As explained above, according to the vehicle-use air bag system of this embodiment, the air bag module can be controlled by the microcomputer 13 of the ECU 10 supplied with electric power from at least one of the first electric power supply path including the ignition switch 30 and the second electric power supply path 42 including the changeover switch 11.

When the microcomputer 13 starts operation by being supplied with electric power from the vehicle battery 20 through the first electric power path 41, the microcomputer 13 turns on the changeover switch 11 so that the microcomputer 13 is supplied with electric power from the vehicle battery 20 through not only the first electric power path 41 but also the second electric power path 42 (step S101). Thereafter, when the condition that the ignition switch 30 is off and the vehicle is stopped is satisfied (YES in steps S102 and S103), the changeover switch 11 is turned off (step S104).

Accordingly, according to this embodiment, it is possible to keep the air bag modules in the controllable sate until the vehicle is stopped even if the ignition switch 30 is turned off while the vehicle is running. The vehicle may free-wheel when the ignition switch 30 is in the off state for a short period of time until the vehicle is stopped, for example, if the ignition switch 30 is manipulated to be turned off, or supply of electric power through the first electric power path 41 is interrupted while the vehicle is running.

In the air bag system of this embodiment, even when the ignition switch 30 is turned off, or power supply to the air bag ECU 10 through the first electric power path 41 is interrupted due to wire breakage of the first electric power supply path 41 while the vehicle is running, the air bag module can be kept in the controllable state until the vehicle is stopped, because the microcomputer 13 is supplied with electric power from the vehicle battery 20 as long as the vehicle is running.

Further, since the microcomputer 13 is not supplied with electric power from the vehicle battery 20 while the vehicle is stopped and the ignition switch 30 is off, the dark current of the air bag system is significantly smaller compared to the conventional structure in which electric power is always supplied from the vehicle battery to the microcomputer irrespective of whether or not the ignition switch is on or off.

In short, the air bag system of this embodiment has the structure that the microcomputer 13 can operate even when the ignition switch 30 is turned off while the vehicle is running without increasing the dark current.

In addition, since the microcomputer 13 of the air bag ECU 10 is configured to compare the vehicle speed measured by the vehicle speed sensor 60 mounted on the vehicle with the stop determination threshold, it is possible to determine whether the vehicle is running or stopped using the existing vehicle sensor 60.

### Other Embodiments

It is a matter of course that various modifications can be made to the above described embodiment of the invention as described below.

(1) The air bag system of the above embodiment can deal with the circumstance that the ignition switch 30 is turned off while the vehicle is running. However, it is not improbable that the vehicle starts moving when the ignition switch is off. For example, if the parking brake is not sufficient when the vehicle is parked on a sloping road, the vehicle may start moving.

To deal with such a case, the above embodiment may further include a structure to turn on the changeover switch 11 when the vehicle is detected to be running while the ignition switch 30 and the changeover switch 11 are both off.

For example, the vehicle speed sensor 60 (or a pair of the vehicle speed sensor 60 and another ECU inputted with the output signal of the vehicle speed sensor 60) may be configured to always operate even when the ignition switch 30 is off, so that the vehicle speed sensor 60 is able to output the command signal directly to the changeover switch 11 even when the microcomputer 13 is out of operation. In this configuration, the vehicle sensor 60 outputs the command signal to turn on the changeover switch 11 while the vehicle speed is not lower than or equal to the stop determination threshold irrespective of whether the ignition switch 30 is in the on state or off state.

According to such a configuration, since the microcomputer 13 is supplied with electric power from the vehicle battery 20 always while the vehicle is running, the air bag module can be kept in the state controllable by the microcomputer 13 even after the vehicle starts moving while the ignition switch 30 is off.

Further, when the vehicle is stopped and the ignition switch 30 is off, the microcomputer 13 is not supplied with electric power from the vehicle battery 20. Accordingly, the dark current can be significantly reduced compared to the case where the microcomputer 13 is always supplied with electric power from the vehicle battery 20 irrespective of whether the ignition switch 30 is on or off.

Incidentally, it is not necessary for the microcomputer 13 to perform the process shown in FIG. 2, if the air bag system is configured such that the changeover switch 11 is kept in the on state by the vehicle speed sensor 60 while the vehicle is detected to be running. It is also possible to configure the air bag system such that the changeover switch 11 is temporarily turned on by the vehicle speed sensor 60 when the vehicle is detected to be running, and thereafter the changeover switch 11 is kept in the on state by the process shown in FIG. 2 performed by the microcomputer 13.

To determine whether the vehicle is running or not, instead of the output signal of the vehicle speed sensor 60, an output signal of a shift position sensor mounted on the vehicle which is inputted to the microcomputer 13 may be used. Further, the air bag system may be configured such that the microcomputer 13 is inputted with the ON signal of a parking brake switch mounted on the vehicle instead of the output signal of the vehicle speed sensor 60, and makes a determination that the vehicle is stopped while the microcomputer 13 receives the ON signal.

(2) In the above embodiment, the microcomputer 13 of the air bag ECU 10 determines whether the vehicle is running or not based on the vehicle speed measured by the vehicle speed sensor 10. However, when an ECU other than the air bag ECU makes a determination whether the vehicle is running or not, the above embodiment may be modified such that the microcomputer 13 receives a determination result from this ECU.

Further, the microcomputer 13 may make a determination whether the vehicle is running or not based on an output signal of other than the vehicle speed sensor 60, for example, a GPS device system or a camera device to take an image ahead of the vehicle.

Further, the air bag system of the above embodiment may be modified such that the microcomputer 13 determines that the vehicle is stopped if the output signal of the shift position sensor indicates that the transmission of the vehicle is in the parking range, and otherwise determines that the vehicle is running. According to such a modification, it is possible to determine whether the vehicle is running or not with very little dark current.

(3) The above embodiment is directed to a vehicle-use air bag system. However, the present invention can be applied to other systems for ensuring safety of a vehicle driver and passengers of a vehicle, such as a pre-crash safety system (a system for reducing damage of an unavoidable collision by tightening seat belts, or moving head rests, for example), and a power steering system.

The above explained preferred embodiments are exemplary of the invention of the present application which is described solely by the claims appended below. It should be understood that modifications of the preferred embodiments may be made as would occur to one of skill in the art.

What is claimed is:

1. A vehicle-use safety control apparatus configured to operate on electric power supplied from a vehicle battery mounted on a vehicle through at least one of a first electric power supply path interposed with an ignition switch of the vehicle, and a second electric power supply path interposed with a switch means, comprising:
a running state information acquiring means to acquire running state information on whether the vehicle is running or stopped; and
a switch control means to change an on/off state of the switch means in accordance with the running state information received from the running state acquiring means.

2. The vehicle-use safety control apparatus according to claim 1, wherein the running state information acquiring means is configured to be able to acquire the running state information irrespective of the on/off state of the ignition switch, and the switch control means is configured to change the on/off state of the switch means in accordance with the running state information received from the running state information acquiring means.

3. The vehicle-use safety control apparatus according to claim 1, wherein the switch control means keeps the switch means in the on state while the running state information indicates that the vehicle is running.

4. The vehicle-use safety control apparatus according to claim 1, wherein the running state information acquiring means continues to acquire the running state information during a period from when the ignition switch is turned on to when the ignition switch is turned off, and during a period from when the ignition switch is turned off to when the acquired running state information indicates that the vehicle is stopped.

5. The vehicle-use safety control apparatus according to claim 4, further comprising a switch state information acquiring means to acquire switch state information indicative of an on/off state of the ignition switch,
the switch control means being configured to turn on the switch means upon being supplied with electric power from the vehicle batty through the first electric power supply path, and thereafter turn off the switch means upon receiving the switch state information indicating that the ignition switch is in the off state from the switch state information acquiring means and the running state information indicating that the vehicle is stopped from the running state information acquiring means.

6. The vehicle-use safety control apparatus according to claim 4, wherein the switch control means turns on the switch means upon being supplied with electric power from the vehicle battery through the first electric power supply path, and thereafter turns off the switch means upon determining that the vehicle has been stopped based on the running state information received from the running state information acquiring means.

7. The vehicle-use safety control apparatus according to claim 4, further comprising a switch state information acquiring means to acquire switch state information indicative of an on/off state of the ignition switch,
the switch control means being configured to turn on the switch means upon determining that the ignition switch has been turned on based on the switch state information received from the switch state information acquiring means, and thereafter turn off the switch means upon determining that the ignition switch has been turned off based on the switch state information received from the switch state acquiring means, and that the vehicle is stopped based on the running state information received from the running state information acquiring means.

8. A vehicle-use safety control apparatus configured to operate on electric power supplied from a vehicle battery mounted on a vehicle through at least one of a first electric power supply path interposed with an ignition switch of the vehicle and a second electric power supply path interposed with a switch means, comprising:
a switch state determination means to determine an on/off state of the ignition switch;
a running state determination means to determine whether the vehicle is running or stopped; and
a switch control means configured to turn on the switch means on condition that the switch control means is supplied with electric power from the vehicle battery through the first electric power supply path, and turn off the switch means on condition that the switch state determination means determines that ignition switch is in the off state, and the running state determination means determines that the vehicle is stopped.

9. The vehicle-use safety control apparatus according to claim 8, wherein the running state determination means determines that the vehicle is stopped if a measurement of a vehicle speed sensor mounted on the vehicle is lower than or equal to a predetermined threshold.
